(19) United States
(12) Patent Application Publication
(10) Pub. No.: US 2005/0156523 A1
(43) Pub. Date: Jul. 21, 2005

(54) Plasma display panel having align marks, and method and apparatus for forming align marks through offset process

(76) Inventors: Young-Hwa Song, Suwon-si (KR); Seung-Heon Oh, Suwon-si (KR); Chang-Seok Rho, Suwon-si (KR); Cheol-Hee Moon, Suwon-si (KR)

Correspondence Address: MCGUIREWOODS, LLP, 1750 TYSONS BLVD, SUITE 1800, MCLEAN, VA, 22102, US

(21) Appl. No.: 11/015,787

(22) Filed: Dec. 20, 2004

(30) Foreign Application Priority Data
Dec. 19, 2003 (KR) 10-2003-0093812

(51) Int. Cl. H01J 17/49; H01J 17/02

(52) U.S. Cl. 313/582; 313/609; 313/610

(57) ABSTRACT

A plasma display panel having a plasma discharge structure in a gap between a first substrate and a second substrate may include an align mark formed on a surface of the first substrate opposing the second substrate. The align mark may include a plurality of cavities. Protrusions may be located within the cavities.

### CROSS REFERENCE TO RELATED APPLICATION

This application claims priority to and the benefit of Korean Patent Application No. 10-2003-0093812, filed on Dec. 19, 2003, which is hereby incorporated by reference.

### BACKGROUND OF THE INVENTION

(a) Field of the Invention

The present invention relates to a plasma display panel (PDP), and more particularly, to a PDP having align marks structured so that they are not formed with defects. The present invention relates also to a method and apparatus for forming the align marks using an offset process.

(b) Description of the Related Art

A PDP is a display device that displays images by exciting phosphors using plasma discharge. Vacuum ultraviolet (VUV) rays emitted from plasma obtained by gas discharge excite phosphor layers. The phosphor layers then emit visible light forming images. With its potential for high resolution and large screen sizes, PDP technology may become the leading next-generation flat screen technology.

In the basic structure of the conventional PDP, address electrodes, barrier ribs, and phosphor layers are formed on a rear substrate, and display electrodes comprised of scan electrodes and sustain electrodes are formed on a front substrate. Each of the scan electrodes and sustain electrodes includes a transparent electrode made of a material having a degree of transmissivity (e.g., indium tin oxide), and a metal bus electrode.

The address electrodes and the display electrodes are covered by a first dielectric layer and a second dielectric layer, respectively. An MgO protective layer is formed on the second dielectric layer. A discharge cell is formed in a discharge space where the address electrodes intersect the display electrodes, and a discharge gas (typically a Ne-Xe compound gas) fills the discharge cells.

The scan electrodes are mounted opposite the sustain electrodes with predetermined discharge gaps between them. The discharge gaps correspond to centers of the discharge cells. The barrier ribs are formed in stripes in the same direction the address electrodes are formed such that the discharge cells are connected in this same direction.

Precise arrangement of the electrodes on the substrates is necessary to accurately align the substrates with each other. With the increased complexity of the transparent electrodes recently, it is increasingly important that the unit cells be properly aligned. Increasing panel size exacerbates the problem of deformation in the glass used in PDPs and in the transparent electrodes. This further complicates the alignment processes during PDP manufacture.

To perform alignment, align marks are formed on the substrates. The align marks may be formed simultaneously during the formation of the electrodes, dielectric layers, and other elements.

Screen printing and photolithography methods are used to form the bus electrodes. Lift-off and thin film methods can also be used to form the bus electrode. There is a recent preference to use offset printing.

### SUMMARY OF THE INVENTION

The present invention can provide an align mark formation method and apparatus that may minimize the amount of align mark paste that is transferred, and may prevent deformation of the align marks during transfer onto a substrate.

It is another object of the present invention to provide a PDP having align marks in which defects in the formation and positioning of align marks are prevented to thereby ensure accurate alignment of the elements of the PDP.

A plasma display panel having a plasma discharge structure in a gap between a first substrate and a second substrate may include at least an align mark formed on a surface of the first substrate opposing the second substrate. The align mark may include a plurality of cavities.

The cavities may be arranged in a substantially uniform pattern with predetermined spaces between adjacent cavities. The spaces may be interconnected to form a lattice pattern.

In another aspect, an outer boundary of the align mark may be defined by an edge, and the cavities at the edge may be closed off by the edge. In yet another aspect, the cavities of the align mark are formed in a lattice pattern.

Each of the cavities may have a cross-sectional shape that is circular or polygonal.

The align marks may be formed using an offset printing process.

An align mark formation method using an offset printing process may include forming in a gravure a concavity in the shape of an align mark to be printed, and simultaneously forming a plurality of protrusions in the concavity. It may further include filling the concavity with a paste for aligning marks, transferring the paste to a printing blanket from the concavity, and transferring the paste to a substrate of a plasma display panel from the printing blanket.

The protrusions may be formed using an etching process. The gravure may be in the form of a plate or in the form of a cylinder.

An align mark formation apparatus may include a gravure having a concavity filled with a paste used to form align marks, a blanket for transferring the paste to a substrate, and a plurality of protrusions formed in the concavity of the gravure plate. The protrusions may have a cross-sectional shape that is circular or polygonal.

### BRIEF DESCRIPTION OF THE DRAWINGS

FIG. 1 is a fragmentary exploded perspective view of a conventional PDP.

FIG. 2 is an exploded perspective view of front and rear substrates of a PDP having align marks according to an embodiment of the present invention.

FIG. 3 is a plan view of an align mark of FIG. 2.

FIG. 4 is a plan view of an align mark according to another embodiment of the present invention.

FIG. 5 is a plan view of an align mark according to yet another embodiment of the present invention.

FIG. 6 is a schematic view of an align mark formation apparatus that utilizes an offset process according to an embodiment of the present invention, illustrating the align mark formation apparatus in a state of use.

FIG. 7 shows sectional views of sequential processes involved in forming an align mark on a substrate according to an embodiment of the present invention.

FIG. 8 is a schematic view of an align mark formation apparatus that utilizes an offset process according to another embodiment of the present invention.

### DETAILED DESCRIPTION

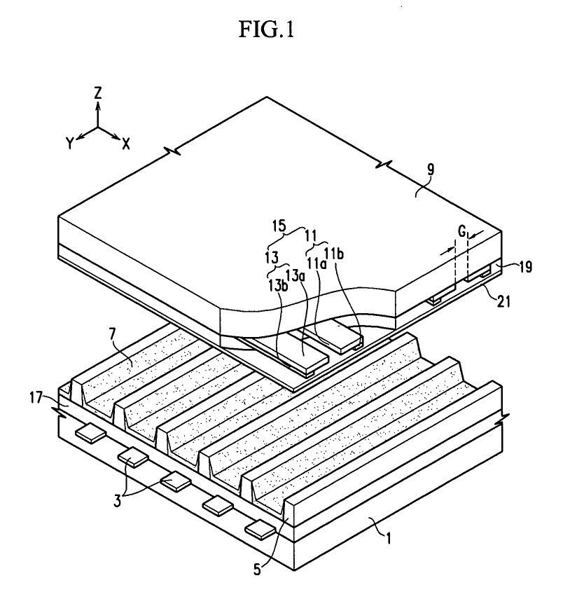

As shown in FIG. 1, address electrodes 3, barrier ribs 5, and phosphor layers 7 may be formed on a first substrate (rear substrate) 1. Display electrodes 15 including scan electrodes 11 and sustain electrodes 13 may be formed on a second substrate (front substrate) 9. Each of the scan electrodes 11 may include a transparent electrode 11 a made of a material such as ITO with a high transmissivity and a bus electrode 11b made of metal. Thus the scan electrode 11 may be conductive.

Similarly, each of the sustain electrodes 13 may include a transparent electrode 13a made of a material such as ITO with a high transmissivity, and a bus electrode 13b made of metal. Thus the sustain electrode 13 may be conductive. The address electrodes 3 and the display electrodes 15 may be covered by a first dielectric layer 17 and a second dielectric layer 19, respectively. An MgO protective layer 21 may be formed on the second dielectric layer 19. Discharge cells may be formed in a discharge region and where the address electrodes 3 intersect the display electrodes 15. A discharge gas (typically an Ne-Xe compound gas) may fill the discharge cells.

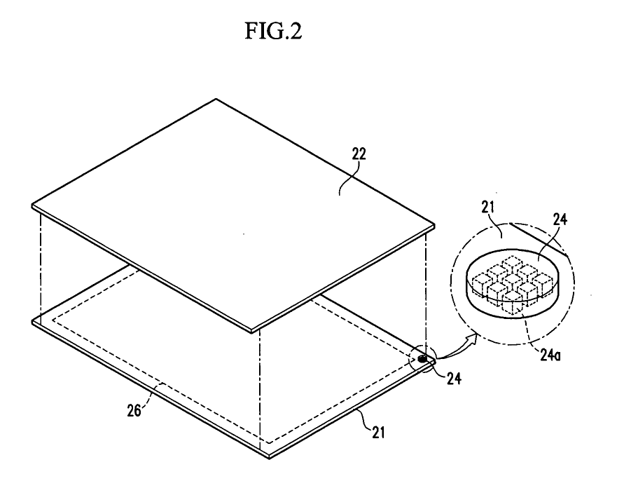

As shown in FIG. 2, discharge structures of the PDP may be formed in a display region 26 positioned within an area where a front substrate 21 and a rear substrate 22 overlap. Align marks 24 may be formed to the exterior of the display region 26. Align marks 24 may be used to align the front substrate 21 and the rear substrate 22 when they are sealed.

The align marks 24 may be formed using an electrode paste during the formation of bus electrodes or address electrodes. The align marks 24 may also be used as points of reference during exposure processes.

As shown in FIG. 2, each align mark 24 according to the present invention may include a plurality of cavities 24a formed within a predetermined area.

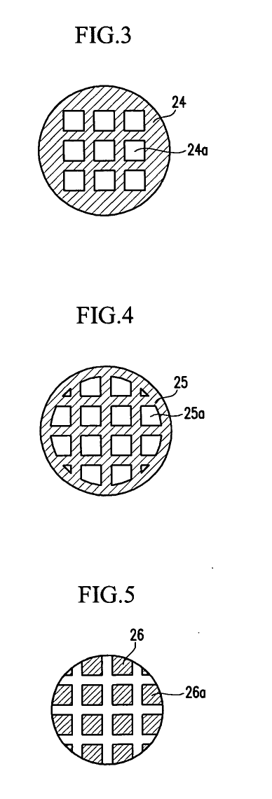

FIG. 3 is a plan view of an align mark 24, shown substantially along a direction normal to the front substrate 21 of FIG. 2. As shown in FIG. 3, the cavities 24a may be arranged in a uniform pattern with predetermined spaces provided between adjacent cavities 24a. The spaces between the cavities 24a may be filled with a paste to realize the predetermined pattern.

As an example, the spaces may be interconnected and form a lattice pattern as shown in FIG. 3.

Grooves may be formed in a gravure plate used in an offset process. After protrusions are formed in the grooves, the grooves may be filled with a paste and printing may be performed. This process may result in the cavities 24a. The cavities 24a may have a cross-sectional shape that is circular, square, rectangular, or the like.

In the first exemplary embodiment, the cavities 24a have a cross-sectional configuration that is square.

The align mark 24 may be interconnected along an edge. On a surface opposing the rear substrate 22, it may be possible for the align mark 24 to be completely interconnected without forming cavities.

As shown in FIG. 4, a plurality of cavities 25a may be formed in an align mark 25, and predetermined spaces may be formed between the cavities 25 as in the previous embodiment. However, the cavities 25a in this embodiment may not all be identical in shape.

The cavities 25a may be formed having a cross-sectional shape that is, for example, square, triangular, and trapezoidal. The outer boundary of the align mark 25 may be defined by an edge, and the cavities 25a at these areas may be closed off by this edge.

As shown in FIG. 5, a plurality of cavities 26a may be formed in an align mark 26 as in the previous embodiments. However, in this embodiment, the cavities 26a may be formed in an interconnected lattice pattern.

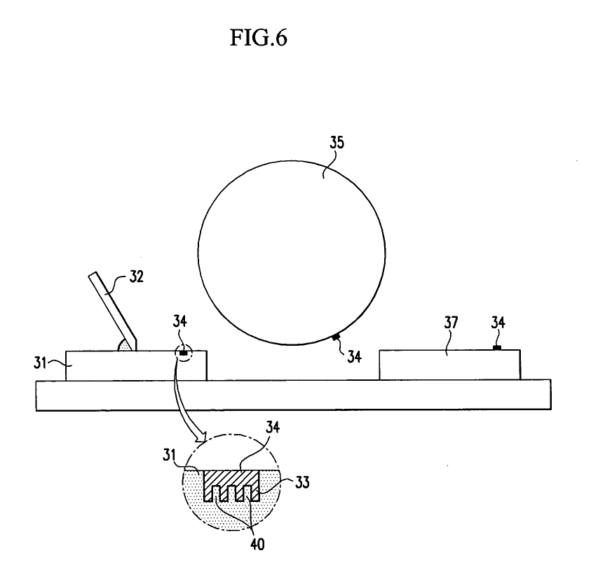

As shown in FIG. 6, a concavity 33 may be formed in a gravure plate 31, and the concavity 33 may be filled with a paste. The paste may then be transferred to a blanket 35. Next the paste may be transferred from the blanket 35 to a glass substrate 37. In actual production, a plurality of the concavities 33 may be formed in the gravure plate 31.

Protrusions 40 may be formed in the concavity 33. The protrusions 40 may have a cross-sectional shape that is circular, square, rectangular, polygonal, or the like.

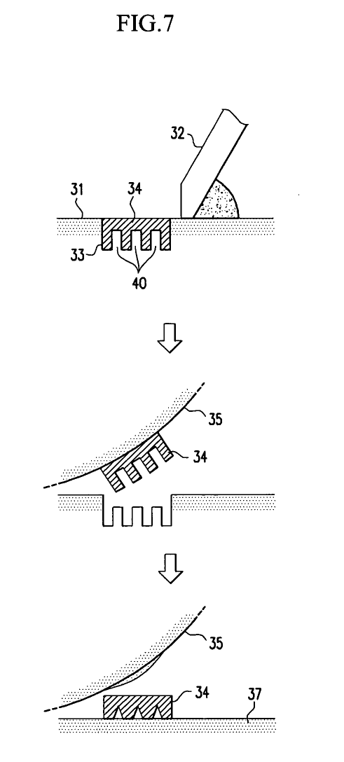

The concavity 33 and the protrusions 40 formed in the gravure plate 31 may be formed by an etching process. In such a case the steps involved may include deposition of a photoresist, exposure using a photomask, and developing. As shown in FIG. 7, a concavity 33 in the shape of an align mark to be printed may first be formed in a gravure plate 31. A plurality of protrusions 40 may simultaneously be formed in the concavity 33. The concavity 33 may then be filled with a paste 34, after which a blade 32 may be used to remove excess portions of the is paste 34 (e.g., overflow paste).

As a result of this formation of the align mark concavity 33 including the protrusions 40 formed at predetermined intervals as described above, the paste 34 may fill between the protrusions 40 rather than within the entire area encompassed by the concavity 33. Hence, the amount of paste 34 required may be reduced by an amount equal to the volume occupied by the protrusions 40.

Next, the paste 34 filled in the concavity 33 may be transferred onto a printing blanket 35. When transferred onto the printing blanket 35, the resulting configuration of the paste 34 may be opposite to the shape of the concavity 33. Locations corresponding to where the protrusions 40 are formed in the concavity 33 may be indented.

Subsequently, the paste 34 transferred onto the printing blanket 35 from the concavity 33 may then be transferred onto a glass substrate 37. During this process, the paste 34 may be squeezed between the printing blanket 35 and the glass substrate 37. Nevertheless, the paste 34 may not undergo any significant outward deformation. This results from the relatively minimal use of the paste 34 as described above. The protrusions 40 thus may ensure that there are sufficient gaps in the paste 34 prior to transfer onto the printing blanket 35.

Thus, when the paste 34 is then transferred onto the glass substrate 37, the squeezing pressure applied to the paste 34 as a result of being pressed between the printing blanket 35 and the glass substrate 37 may be applied in an inward direction toward the gaps formed in the paste 34. This prevents an outwardly distorted formation of the align marks.

In the offset printing process, the align marks are typically formed during electrode formation. The paste may be transferred onto a cylindrically shaped blanket made of silicone rubber, and the blanket may contact the substrate and roll on it. Thus the paste may be transferred onto the substrate.

In the conventional process, with the pressure applied to the align marks in the direction of movement of the blanket, the align marks are not positioned correctly, and are frequently deformed.

However, with the use of the align mark formation method of the exemplary embodiment of the present invention described above, problems in position or formation of the align marks may not occur.

Following the transfer of the paste 34 onto the glass substrate 37, drying and firing of the paste 34 may be performed to thereby complete the formation of the align marks. The align marks may be formed at the same time electrode formation takes place as described above.

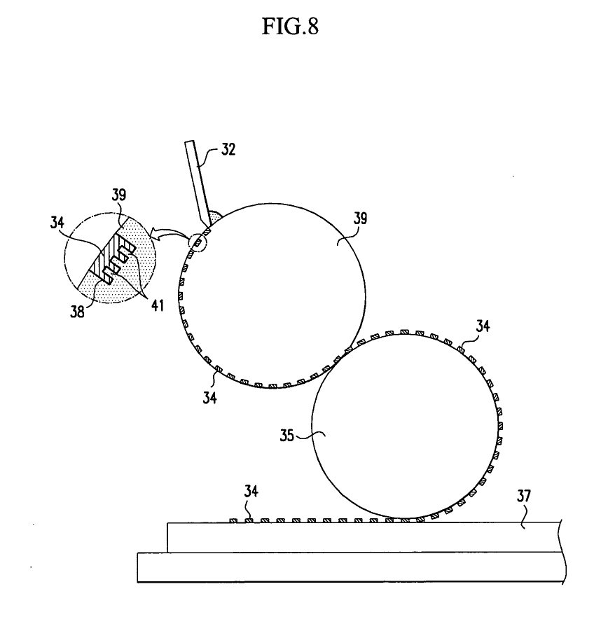

As shown in FIG. 8, concavities 38 may be formed in a gravure roll 39, and the concavities 38 may be filled with a paste. Following filling of the concavities 38, the paste may be transferred to a glass substrate 37.

As with the previous embodiment, an etching process may be performed on the surface of the gravure roll 39 to thereby form the concavities 38. A plurality of protrusions 41 may be formed in each of the concavities 38. The protrusions 41 may have a cross-section that is circular, square, rectangular, polygonal, or the like. The protrusions 41 may be formed at the same time as the concavities 38.

The concavities 38 may be filled with a paste 34. Next, a blade 32 may be used to remove excess portions of the paste 34 (e.g., overflow paste). Subsequently, the paste 34 filled in the concavities 39 may be transferred onto a printing blanket 35. The paste 34 may finally be transferred onto a glass substrate 37. Drying and firing may then be performed to complete the align marks.

Although embodiments of the present invention have been described in detail hereinabove, many changes may be made to the embodiments without departing from the scope of the invention.

1. A plasma display panel, comprising:
an align mark formed on a surface of a first substrate opposite a second substrate, the align mark comprising a plurality of cavities.

2. The plasma display panel of claim 1, wherein the cavities are arranged in a substantially uniform pattern with predetermined spaces provided between adjacent cavities.

3. The plasma display panel of claim 2, wherein the spaces interconnect in a lattice pattern.

4. The plasma display panel of claim 1, wherein an outer boundary of each of the align mark is defined by an edge, and the cavities at the edge are closed off by the edge.

5. The plasma display panel of claim 1, wherein the cavities of the align mark form a lattice pattern.

6. The plasma display panel of claim 1, wherein each of the cavities has a cross-sectional shape that is either circular or polygonal.

7. The plasma display panel of claim 1, wherein the align mark is formed using an offset printing process.

8. A method for forming an align mark using an offset printing process, comprising:
forming in a gravure a concavity in the shape of an align mark to be printed;
simultaneously forming a plurality of protrusions in the concavity;
filling the concavity with a paste used for align mark;
transferring the paste to a printing blanket from the concavity; and
transferring the paste to a substrate of a plasma display panel from the printing blanket.

9. The method of claim 8, wherein forming the plurality of protrusions comprises etching.

10. The method of claim 8, wherein the gravure comprises a plate.

11. The method of claim 8, wherein the gravure comprises a roll.

12. The method of claim 8, further comprising removing excess paste prior to transferring the past to the printing blanket.

13. The method of claim 12, wherein removing excess paste comprises applying a blade to the surface of the gravure.

14. An align mark formation apparatus, comprising:
a gravure having a concavity filled with a paste used to form align marks;
a blanket for transferring the paste to a substrate; and
a plurality of protrusions formed in the concavity of the gravure.

15. The align mark formation apparatus of claim 14, wherein the protrusions have a cross-sectional shape that is one of circular and polygonal.

16. The align mark formation apparatus of claim 14, wherein the gravure comprises a plate.

17. The align mark formation apparatus of claim 14, wherein the gravure comprises a roll.

18. The align mark formation apparatus of claim 14, wherein the plurality of protrusions are arranged to minimize the paste required.
